(19) United States
(12) Patent Application Publication
(10) Pub. No.: US 2015/0161843 A1
(43) Pub. Date: Jun. 11, 2015

(54) Gaming Machine Adapts Game Based on Attributes of Player's Voice

(71) Applicant: Spielo International Canada ULC, Moncton (CA)

(72) Inventor: Stefan Keilwert, Lannach (AT)

(73) Assignee: Spielo International Canada ULC, Moncton (CA)

(21) Appl. No.: 14/101,598

(22) Filed: Dec. 10, 2013

(51) Int. Cl. G07F 17/32

(52) U.S. Cl. CPC G07F 17/3209

(57) ABSTRACT

At least one microphone is incorporated in a gaming machine along with voice recognition/analysis software that analyzes the quality of the player's voice to determine the player's age, gender, emotions, and other attributes. Such voice attributes are not direct voice commands by the player, but are voice characteristics that provide information about the player herself. After the player is characterized based on her voice attributes, game software is modified accordingly so that the game is customized for the particular player. For example, the detection that the player is a young woman may cause the game to use a certain theme involving young female characters, trendy modern music, etc. The game also adapts to the detected voiced emotions of the player. Other features of the machine cause there to be verbal interaction between the player and the machine, enhancing the playing experience.

### FIELD OF THE INVENTION

This invention relates to gaming machines and, in particular, to a gaming machine that controls aspects of the game based on sensing attributes of the player's voice, as opposed to voice commands, so the game is customized to the player.

### BACKGROUND

Conventional gaming machines, also referred to as slot machines, do not detect a player's voice. However, it is known to control aspects of a gaming machine by voice commands. U.S. Pat. No. 7,922,583 describes a synthesized sound system for a gaming machine that can generate customized sounds, as opposed to pre-recorded sounds, based on vocal commands by the player. The gaming machine of the '583 patent includes speech recognition logic. For example, the gaming machine may generate sounds in a language directly specified by the player. Another feature of the machine is that the player may state her name, and the gaming machine accesses a stored central file identifying game preferences associated with that player. The machine then implements the preferences.

It is also known to centrally store preferences for a player, previously generated by the player or by the player's past actions, which are implemented when the player uses a player tracking card.

In addition to implementing voice commands and stored preferences, it may also be desirable to somehow customize the game to the player's personal characteristics, and even the player's dynamic emotions during a game, without requiring direct instructions to the gaming machine. For example, the player may enjoy the game more if it were customized for the player's age and gender and if the game interacted with the player based on the player's reactions.

### SUMMARY

A gaming machine includes a microphone, speakers, a sound synthesizer, an analog-to-digital converter, voice analysis algorithms, and processing tools to enable the machine to control sensory aspects of the game based on attributes of the player's voice.

In one embodiment, the player speaks to the machine, and the machine directly detects the gender of the player based on the tonal quality and adapts all sounds and graphics to the player's gender, such as by using female characters and themes.

In another embodiment, the player speaks to the machine, and the machine directly detects the age of the player, by detecting age-related characteristics of the voice, and adapts all sounds and graphics to the player's age, such as by adding treble, increasing volume, and increasing the size of certain words on the screen.

In another embodiment, the player speaks to the machine, and the machine directly detects the language of the player and adapts all sounds and graphics to the player's native language.

In another embodiment, the player's vocal expressions during the game are detected, and the machine automatically reacts to the expression with a suitable sound or graphics to encourage the player to become more vocally interactive with the machine. Such expression may be a cheer by the player or observers of the game.

Other examples are provided of ways in which the machine adapts the game based on the player's vocalizations, rather than the player's direct commands. Such other examples include varying the win frequency upon sensing the player's emotions, varying the user interface for the player's age, varying the intensity of haptic effects for the player's age, etc.

In conjunction with the game being adapted to the player by detecting attributes of the player's voice, the gaming machine also takes suitable actions upon given vocal commands by the player, such as the name of the game to be played, changing the volume, betting amounts, etc. The player may say her name when prompted or use a player tracking card, which addresses a stored set of preferences for the player and applies those preferences to the machine.

The machine also senses ambient noise and adjusts the sound volume and/or equalization (e.g., raising the volume within a certain frequency band) to cause the sound to be better heard in the environment. The gaming machine may also use stereo microphones to detect the position of the player's head when speaking and change the phase and volume of the stereo loudspeakers accordingly.

Any game can be played on the gaming machine.

Other features are described.

### BRIEF DESCRIPTION OF THE DRAWINGS

FIG. 1 is a perspective view of one type of gaming machine that is programmed to carry out the inventive technique.

FIG. 2 is a block diagram showing the basic functional units in the gaming machine of FIG. 1.

FIG. 3 is a flow chart of the basic method carried out using one embodiment of the new technique.

### DETAILED DESCRIPTION

Although the invention can typically be implemented by installing a software program, microphone, and A/D converter in most types of modern video gaming machines, one particular gaming machine platform will be described in detail.

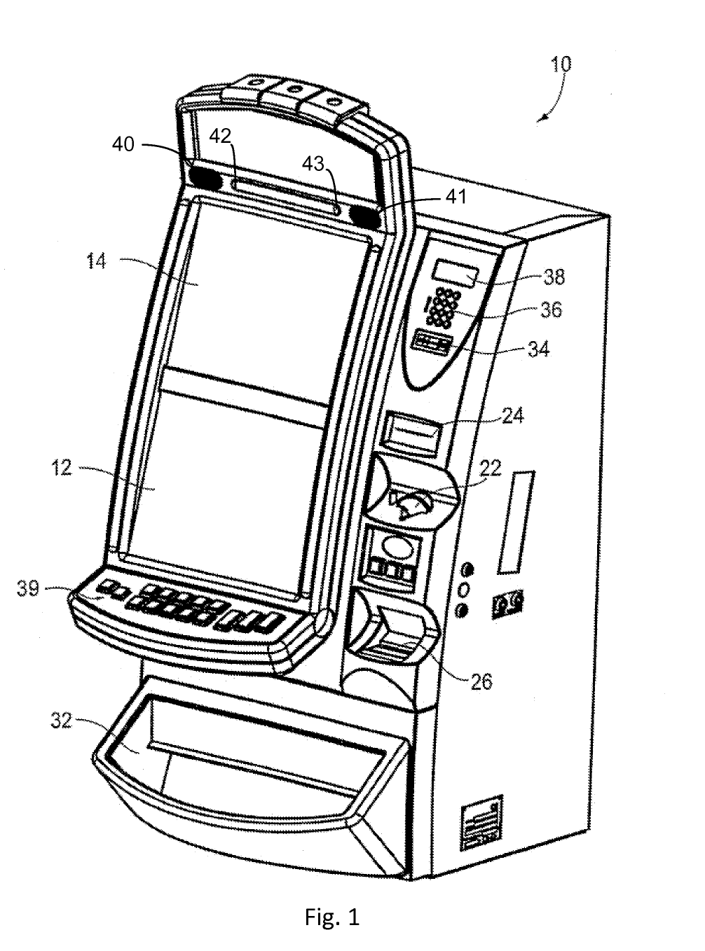

FIG. 1 is a perspective view of a gaming machine 10 that incorporates the present invention. Machine 10 includes a display 12 that may be a thin film transistor (TFT) display, a liquid crystal display (LCD), a cathode ray tube (CRT), or any other type of display. A second display 14 provides game data or other information in addition to display 12. Display 14 may provide information such as an advertisement for the game, the rules of the game, pay tables for each bet amount, the different blocks of symbol positions associated with their associated bet amount to determine winning symbol combinations, or other information, or may even display the main game or the bonus games along with display 12. Alternatively, the area for display 14 may be a display glass for conveying relevant information.

Display 12 or 14 may have a touch screen lamination that includes a transparent grid of conductors. Touching the screen changes the capacitance between the conductors, and thereby the X-Y location of the touch may be determined. The processor associates this X-Y location with a function to be performed. Such touch screens are very well known in the field of slot machines.

A coin slot 22 accepts coins or tokens in one or more denominations to generate credits within machine 10 for playing games. An input slot 24 for an optical reader and printer receives machine readable printed tickets and outputs printed tickets for use in cashless gaming. A bill acceptor 26 accepts various denominations of banknotes.

A coin tray 32 receives coins or tokens from a hopper upon a win or upon the player cashing out.

A card reader slot 34 accepts any of various types of cards, such as smart cards, magnetic strip cards, or other types of cards conveying machine readable information. The card reader reads the inserted card for player and credit information for cashless gaming. The card reader may also include an optical reader and printer for reading and printing coded barcodes and other information on a paper ticket.

A keypad 36 accepts player input, such as a personal identification number (PIN) or any other player information. A display 38 above keypad 36 displays a menu for instructions and other information and provides visual feedback of the keys pressed.

Player control buttons 39 include any buttons needed for the play of the particular game or games offered by machine 10 including, for example, one or more bet buttons, a repeat bet button, a spin reels button, a maximum bet button, a cash-out button, a display payout tables button, select icon buttons, and any other suitable button. Buttons 39 may be replaced by a touch screen with virtual buttons. Any user controls may also be implemented as icons on the touch screen main display 12.

Stereo speakers 40 and 41 play stereo sounds for game effects and allow the machine 10 to verbally ask the player questions.

Stereo microphones 42 and 43 detect the player's voice and ambient sounds.

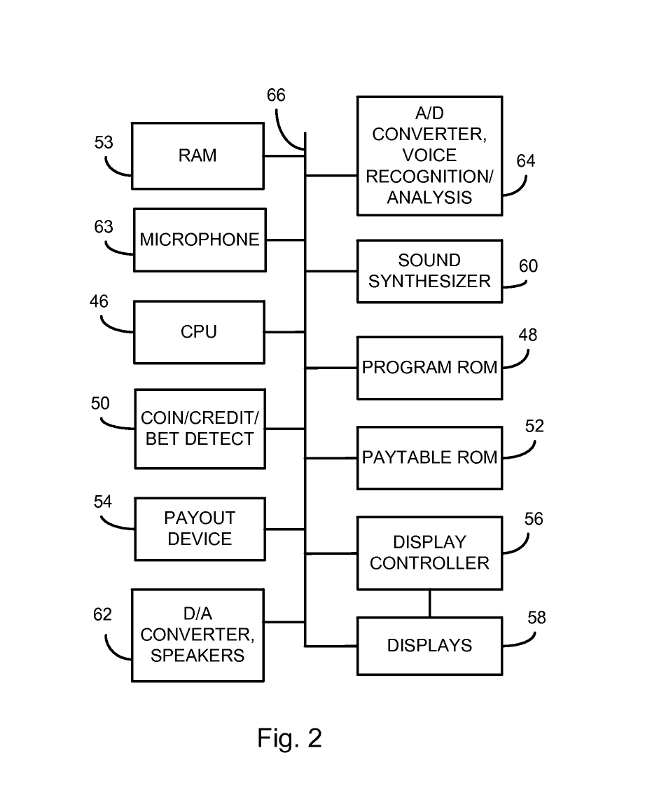

FIG. 2 illustrates basic circuit blocks in a suitable gaming device. One or more processors (CPU 46) run a gaming program stored in a program ROM 48 (e.g., a CD). A coin/credit detector 50 enables the CPU 40 to initiate a next game. The coin/credit/bet detector 50 may detect coins or stored credits, which may have been downloaded pursuant to the player inserting a paper ticket with a bar code associated with a number of credits, and detects the player's bet. A paytable ROM 52 detects the outcome of the game and identifies awards to be paid to the player. A RAM 53 stores all or portions of the game program (downloaded from the program ROM 48) while the machine is being used. A payout device 54 pays out an award to the player in the form of coins or a coded paper ticket upon termination of the game or upon the player cashing out. A payout may also be in the form of credits on a smart card or magnetic strip card, or in any other form. A display controller 56 receives commands from the CPU 46 and generates signals for the various displays 58. If a display 58 is a touch screen, player commands may be input through the display screen into the CPU 46.

A sound synthesizer 60 receives digital commands from the CPU 46 to generate various sounds codes, and the codes are converted to analog signals by a digital-to-analog converter and applied to the speakers 62. One or more microphones 63 detect the player's voice and ambient sounds. The microphone signals are converted to digital codes by an analog-to-digital converter and processed by voice recognition/analysis software 64. The voice recognition/analysis software 64 contains algorithms for detecting at least: the player's gender, age, emotions (e.g., excitement level), commands, language, and other attributes.

The various elements may be connected to a single bus 66 or connected via other paths for being controlled by the CPU 46.

The gaming machine 10 will typically be connected, via a network in the casino, to a central processing system that monitors a network of gaming machines and detects aspects of the player's game play. In some cases, the gaming machine 10 is a client device and the central processing system performs all the game decisions, where the gaming machine 10 acts as a display device and a user interface.

### Operation of Gaming Machine Incorporating Invention

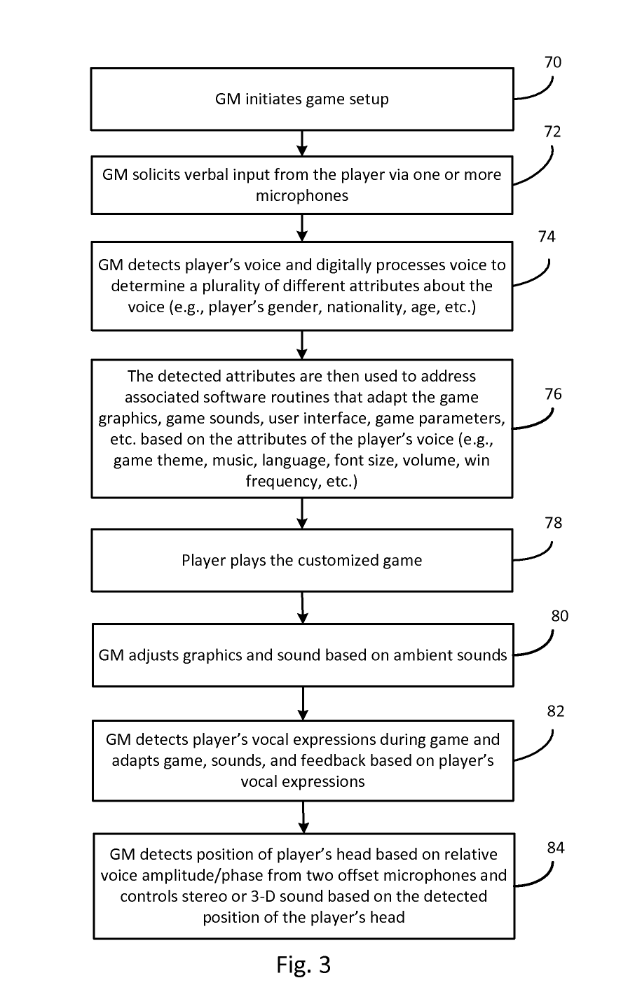

The operation of the gaming machine of FIG. 1 will be described with respect to the flowchart of FIG. 3.

The player initially deposits money into the gaming machine, either by cash, ticket, or download, to accumulate credits for later betting. In step 70, the gaming machine 10 detects that the player has deposited “new” credits in the machine 10 (after the previous player cashed out), and the machine 10 carries out an initialization routine to set up the games.

In step 72, the machine 10 prompts the player, using either graphics or by a generated voice emitted by the speakers 40/41, to speak or answer questions. The machine 10 may simply introduce itself and solicit any verbal response by the player. It is preferable that the machine 10 interact with the player in a conversational manner to make the player feel free to verbally interact with the machine 10. The player will typically not know the extensive capability of the machine 10 to interpret spoken words and supply a suitable response. Accordingly, the player may feel that it is sharing the playing experience. Algorithms for allowing a computer to converse with a human are commonly used in smartphones, and such algorithms may be adapted for the gaming machine 10.

In one embodiment, the machine 10 may ask the player a few questions about personal preferences and asking the player's name. The player may then provide direct commands to the machine 10 about which game to play, assuming the ROM 48 stores a plurality of games. Other preferences, such as language, brightness, volume, tone, speed of play, and other features may be directly stated verbally by the player, and the machine's voice recognition/analysis software 64 in conjunction with the CPU 46 and program ROM 48 implement the player's desired features.

The present invention is directed to the machine 10 adapting the game based on attributes of the player's voice, which identify personal characteristics of the player (steps 74, 76, and 78), where the player may even be unaware that her voice is being processed by the machine 10 to control aspects of the game.

The player is encouraged by the machine 10, either by the graphics or by audio, to be vocal and expressive, and the machine 10 provides feedback encouraging such expressiveness.

In one embodiment, the machine directly detects the spoken language of the player and adapts all sounds and graphics to the player's own language and native country. For example, if the player is detected as being Spanish, a Spanish game theme and Spanish music may be automatically implemented.

In another embodiment, the player speaks to the machine, and the machine directly detects the gender and age of the player and adapts all sounds and graphics to the player's gender and age. Age and gender detection software is known and commercially available, such as from Nuance Communications, Inc., and the detection is based on the pitch, frequency, modulation, and timbre in the voice. There are many possible algorithms, published and commercially available, that can be used to detect gender and age.

For example, the graphics, music, sounds, and theme in a game may be automatically selected to be geared for a young woman, such as using modern (e.g., rock) music, trendy themes, a young female character in the game, etc. For a much older woman, the music selected may be swing or orchestra music and the game theme may be geared to a less trendy theme. A male player may hear music and sounds typically preferred by men, the game character may be a male of a similar age, and the sounds and graphics are also age related. The game automatically selected for a younger player may be more complex and faster than the game selected for a much older player. A game may be sped up by, for example, changing reel stop timings, and speeding up other animation timings, including animations in bonus games. Thus, all players may receive a different playing experience that is customized based on their voice attributes during the set up phase or during the game rather than a direct command.

If the voice recognition/analysis software detects that the player is particularly old, the machine 10 may increase the volume and add more treble. The graphics may automatically become simplified, and the speed of play may be slowed. Fonts may be increased in size to account for poorer eyesight. The loudness of the player's voice is also analyzed, and a louder voice typically coincides with the need for louder volume from the speakers 40/41.

The ambient sounds may also be detected, and the machine 10 automatically varies the volume and the equalization (step 80). For example, if there is an abundance of low frequency ambient sounds, the sound synthesizer 60 will increase the low frequency level of the sounds to compensate. Conversely, if there is an abundance of high frequency ambient sounds, the sound synthesizer 60 will increase the high frequency level of the sounds to compensate. More detail of the operation of a sound synthesizer may be obtained from U.S. Pat. No. 7,922,583, incorporated herein by reference.

During a game, the player's vocal expressions are detected, such as cheering sounds after a win or disheartening sounds after a loss, and the machine automatically reacts to the expression with a suitable sound or graphics to encourage the player (step 82). This makes the player aware of the interactive nature of the machine 10 and the player becomes more vocally interactive with the machine 10, adding to the fun. Such expression may also be a cheer by observers of the game.

For example, the player may cheer after a win, and the machine 10 will generate an audio message or a graphic message congratulating the player by name and making a suitable remark in response to the particular cheer. There will be a variety of responses by the machine 10 to avoid repetition. Similarly, for a loss by the player, the machine 10 may generate an encouraging phrase using the player's name and may even provide the player a free game. Preferably, the machine's remark will be adapted to the player's remark. Generally, the machine 10 software measures player's excitement as feedback during the game experiences, such as the player's reaction to the generation of near-miss effects, reaction upon big wins, or reaction upon a string of losing games. The machine 10 may also adapt the games to calm the player, such as by selecting games with a higher win frequency (e.g., CPU 46 changes the symbol probabilities in the random number generator and changes the pay out table).

The machine 10 may even detect the emotion in the player's voice, using particular software in the voice recognition/analysis software 64. “Emotion” detection software is available from Verbal Communication, Ltd., http://www.beyondverbal.com, and described in U.S. Pat. Nos. 8,078,470 and 8,249,875, incorporated herein by reference. In response to the detection of such emotion, the machine 10 may create an audio message, or show the message graphically, that encourages the player and makes the player feel better.

The analysis of the player's moods in response to the game may be centrally stored to build a player-characteristics profile to help the machine 10 provide the optimal games for the player. All machines are connected via a network, so any linked machine may use the stored profile to adapt the games to the player once the player has identified herself via a player tracking card or her spoken name. The system is self-learning over time. The profile may even obtain data from any land-based, on-line, mobile, or other gaming device.

Besides the gaming machine adapting the game graphics and sounds to the player based on the player's voice attributes, the gaming machine may adapt the user interface and game parameters to the player. Some examples of such further customization of the gaming experience are as follows:
Player gender dependent fragrances are sprayed into the air, supporting positive experiences of special gameplay situations (e.g., winning).
A player's age influences to what degree touchscreen haptic and vibrating effects are used (e.g., more intense for younger players) to optimize the human-machine interface.
Touchscreens whose surfaces can be modified dynamically to create 3D-structures can generate embossed printing on screen (e.g., on top of written messages on screen) according to the player's spoken language.
Optimize the viewing experience by changing the height of the display(s) or the angle of the display(s) with respect to the player's mouth (the speech source). This can be especially useful for 3D-graphics. This requires two spaced microphones.
Turning any video cameras towards the player's head (speech source).
Adapt the intensity of haptic effects/rumble of chairs/other hardware effects according to the player's excitement level.
Moving the flat screen display to an optimal position in front of the player's eyes based on the detected location of the player's voice (requires 2 or 3 space microphones).
Changes the height of the player's seat based on the detected location of the player's voice to optimize the seat for viewing and using the player controls.
The mathematical part of a game may react upon an analyzed excitement level of a player: to further emphasize excitement (more frequent wins, near-miss effects, random wins, etc.) or to de-emphasize a player's excitement (e.g., reduce frequency/height of wins).
Math-characteristics (e.g. volatility, % return to player, win-amounts) are chosen (player profiles) based on player's age and gender.

Varying any of the above features of the game experience is easily implemented using known techniques, once the decision has been made to implement the customization based on the classification of the player's voice attributes.

Below is a list of the possible voice attributes that are analyzed by the gaming machine software (e.g., block 64 in FIG. 2) and the possible classifications, based on the voice attributes, in order to customize the gaming experience.
Loudness
Spoken language
Gender classification
Age
Excitement level
Rate of speech
Timbre/tone
Tone pitch
Mood/Expressions
Direction of speech source

Accordingly, at least one microphone incorporated in the gaming machine, along with voice recognition/analysis software, is used to determine the player's age, gender, emotions, nationality, volume, and other attributes that provide information about the player herself. Such attributes are in contrast with direct voice commands by the player that simply tell the gaming machine what the player wants. Such detected attributes are used by the gaming machine to create a customized game for the player, including adapting any sensory aspect of the game experience to the player, and the player may not even realize that such customization is even taking place.

In one embodiment, there is a plurality of possible attributes that the player may be classified under, and there is a best-fit algorithm to determine how the player's voice sound waves correspond to the various possible attributes. For example, the age-related detection algorithm may classify the player as either under 21, between 21-40, between 41 and 60, between 60 and 70, and over 70. Once the attributes of the player are determined (e.g., age, gender, nationality, etc.), a look-up table may be applied to each detected attribute of the player. The look-up table identifies the associated changes to be made to the graphics and audio to customize the game for the player. Each look-up table output may correspond to a different software program/routine that the machine runs to implement the change to the basic game (step 76). The underlying mathematics for the game do not change, so there is no advantage for any particular characteristic. The look-up table may be part of the program ROM 48 in FIG. 2, since it is just a portion of the memory. There may be any number of possibilities for each of the voice attributes that can be detected.

Alternatively, instead of a look-up table storing preprogrammed customizations of the game, a processor may perform algorithms of the detected attributes to determine the customization of the game.

In another embodiment, there is a separate microphone on both sides of the machine 10, and the machine 10 detects the position of the player by detecting the relative volume or phases received by the microphones. The stereo sound output by the speakers 40/41 is then adjusted for the player's position (step 84). For example, if the player is detected as being nearer the left side of the machine 10, the left speaker 40 volume would be reduced and the right speaker 41 volume would be increased. Such adjustment may also be made to compensate for the directionality of ambient sounds. The microphones also allow the machine 10 to perform ambient noise cancellation, which is partially dependent on the position of the player's head relative to the speakers 40/41. Three-dimensional audio effects are also possible by knowing the position of the player's head relative to the speakers 40/41.

The gaming device's sound technology may be capable of processing sonic waves not only in the hearable range, but also outside of it. Ultrasonic waves might be used to interact and exchange information with other devices or to create special effects, such as ultra low frequencies. The speaker system may provide technologies to sound-beam audio to specific areas within the environment of the gaming machine 10. For example, relevant sounds may be generated so that they are only hearable by the player. Special scenarios might be advertised specifically to the player's neighbors as well. Other events might be audible for spectators or the entire environment of the gaming machine 10 (e.g., jackpot triggers, jackpot hits, etc.).

Further, based on the analyzed audio environment of the gaming machine 10, the machine 10 is able to choose the proper communication channel for the player. For example, in a very noise environment, information for the player is dynamically adjusted to be visually displayed, instead of using audio, rather than simply turning up the volume to add to the noisy environment. All gaming machines in a casino may be equipped with this feature to control a maximum volume in the casino, depending on the number of active players. Other interface possibilities may be provided in the machine 10, such as vibrating (haptic) user interfaces (e.g., buttons, touch screen, etc.), to prompt the player or to confirm interactions.

Any game can be played, such as the random selection of symbols in an array where the combination of symbols across paylines grants awards in accordance with a paytable, video poker, bonus games of any type, wheel spinning games, keno games, multiple choice games, etc.

The audio detection may be enhanced by the visual detection of the player's face. The video detection is performed by a camera installed in the machine 10. The face analysis may be compared to the voice analysis to increase the confidence level of the assessment of age, gender, mood, etc. of the player.

The technique may be carried out on a stand-alone machine, or on a machine connected to a server, or may be played on-line with a home computer connected to a server via the Internet, or may be played on a smartphone or tablet via the Internet, or by other processing devices. In such “personal” computing devices, a microphone is already included in the body of the device, and a software program is typically downloaded from the Internet or via a memory to give the device the capability of carrying out the present invention. If all software to carry out the game is downloaded, then connection to the Internet may not be needed to carry out the game.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method performed by a gaming device, the gaming device comprising at least a display and a processing system, the method comprising:
detecting a player's voice via at least one microphone, the at least one microphone being part of the gaming device;
processing voice signals from the microphone, using one or more processors running a software program, to analyze attributes of the player's voice relating to personal characteristics about the player, wherein detected attributes convey at least one of the player's age, player's gender, and player's emotion; and
controlling one or more sensory aspects of a game played on the gaming device based on the detected attributes of the player's voice.

2. The method of claim 1 further comprising:
applying the detected attributes of the player's voice to a look-up table, the look-up table associating each attribute with a particular change to the game; and
customizing at least one of game graphics and game sounds to the player based on the attributes of the player's voice.

3. The method of claim 1 wherein the step of controlling the one or more sensory aspects of the game played on the gaming device comprises controlling visual aspects of the game played on the gaming device.

4. The method of claim 1 wherein the step of controlling the one or more sensory aspects of the game played on the gaming device comprises controlling audio aspects of the game played on the gaming device.

5. The method of claim 1 wherein the step of controlling the one or more sensory aspects of the game played on the gaming device comprises controlling both visual and audio aspects of the game played on the gaming device.

6. The method of claim 1 wherein the step of controlling the one or more sensory aspects of the game played on the gaming device comprises controlling a user interface for the game played on the gaming device.

7. The method of claim 1 wherein the step of controlling the one or more sensory aspects of the game played on the gaming device comprises causing the game to use gender-specific graphics and sounds in response to the attributes conveying a gender of the player.

8. The method of claim 1 wherein the step of controlling the one or more sensory aspects of the game played on the gaming device comprises causing the game to use age-specific graphics and sounds in response to the attributes conveying an age of the player.

9. The method of claim 1 wherein the step of controlling the one or more sensory aspects of the game played on the gaming device comprises one of more of the following: dispensing player gender-dependent fragrances; adjusting touchscreen haptic and vibrating effects; changing a height of a display screen; changing an angle of the display; adapting the intensity of haptic effects according to the player's excitement level; changing a height of the player's seat; and changing mathematics of the game.

10. The method of claim 1 wherein the attributes of the player's voice include one or more of the following attributes: loudness, spoken language, gender-related characteristics, age-related characteristics, excitement level, rate of speech, timbre, tone, pitch, mood, and direction of speech source.

11. The method of claim 1 wherein the gaming device includes a plurality of microphones, the method further comprising detecting a position of the player's head by sensing differences in audio signals received by the microphones and controlling the one or more sensory aspects of the game played on the gaming device based on the position of the player's head.

12. The method of claim 11 wherein the step of controlling the one or more sensory aspects of the game played on the gaming device based on the position of the player's head comprises controlling stereo sounds emitted by stereo speakers.

13. The method of claim 11 wherein the step of controlling the one or more sensory aspects of the game played on the gaming device based on the position of the player's head comprises controlling game graphics.

14. The method of claim 1 wherein the gaming device comprises a stand-alone gaming machine.

15. The method of claim 1 wherein the gaming device comprises an on-line device that carries out the game via the Internet.

16. The method of claim 1 wherein the gaming device comprises a smartphone.

17. A gaming system comprising:
a display;
a microphone; and
a processing system, wherein the processing system is programmed to carry out the method comprising:
detecting a player's voice via the microphone;
processing voice signals from the microphone to analyze attributes of the player's voice relating to personal characteristics about the player, wherein detected attributes convey at least one of the player's age, player's gender, and player's emotion; and
controlling one or more sensory aspects of a game played on the gaming system based on the detected attributes of the player's voice.

18. The system of claim 17 wherein the processing system comprises a look-up table, and wherein the processing system is further programmed to carry out the method comprising:
applying the detected attributes of the player's voice to the look-up table, the look-up table associating each attribute with a particular change to the game; and
customizing at least one of game graphics and game sounds to the player based on the attributes of the player's voice.

19. The system of claim 17 wherein the step of controlling the one or more sensory aspects of the game played on the gaming system comprises controlling both visual and audio aspects of the game played on the gaming system.

20. The system of claim 17 wherein the attributes of the player's voice include one or more of the following attributes: loudness, spoken language, gender-related characteristics, age-related characteristics, excitement level, rate of speech, timbre, tone, pitch, mood, and direction of speech source.
